(19) United States
(12) Patent Application Publication
(10) Pub. No.: US 2012/0110857 A1
(43) Pub. Date: May 10, 2012

(54) RAZOR CARTRIDGE

(76) Inventors: Mark PETERSON, Reading (GB); Stephen Leonard RAWLE, Newbury (GB); Trevor John WHELAN, Thatcham (GB)

(21) Appl. No.: 13/282,590

(22) Filed: Oct. 27, 2011

(30) Foreign Application Priority Data
Nov. 4, 2010 (EP) 10190049.6

(51) Int. Cl. B26B 21/22

(52) U.S. Cl. 30/50

(57) ABSTRACT

A wet shaving razor cartridge has a housing, a primary blade and a final blade. The primary blade is located at a front end of the cartridge and the final blade is located at a rear end of the cartridge. The primary and final blades have blade edges that extend in parallel to a length of the housing. An angle αₚ between the primary blade and a blade plane is greater than an angle α_{f} between the final blade and the blade plane. The blade plane is tangential to the primary blade edge and the final blade edge.

### FIELD OF THE INVENTION

This invention relates to a wet shaving razor cartridge having at least two blades, where the primary blade is positioned at a greater angle relative to a blade plane than the final blade.

### BACKGROUND OF THE INVENTION

Safety razors used for wet shaving are well known. Over the years, wet shaving razors have evolved to include a multiplicity of blades with the goal of increasing the closeness of the shave that is achieved while also still providing a comfortable shaving experience. Razors currently on the market strive to achieve an optimum balance between efficiency, closeness and comfort of a shave. Achieving this balance is made difficult because of the many different types of hair, different shaving habits and variables of a razor cartridge that influence the shaving characteristics of a safety razor.

One such variable is the angle at which blades are presented to skin to be shaven. Wet shaving razors currently manufactured and sold by The Gillette Company® in the Fusion® range have five blades, positioned at an angle of 21.5° relative to a blade plane. Over the years, a considerable amount of research has been done to arrive at this optimal angle for blades in a cartridge that enables a close, efficient shave, without causing a user an unacceptable level of discomfort. In this respect, increasing the angle of the blades leads to an increase in efficiency and closeness of a shave but a decrease in comfort levels experienced by a user.

The present invention seeks to further improve the balance between closeness and comfort of a shave.

### SUMMARY OF THE INVENTION

According to a first aspect of the invention, there is provided a wet shaving razor cartridge, comprising a housing, a primary blade located at a front end of the housing and a final blade located at a rear end of the housing, the primary and final blades having blade edges that extend in parallel to a length of the housing, a blade plane tangential to the primary blade edge and the final blade edge, wherein an angle αₚ between the primary blade and the blade plane is greater than an angle α_{f} between the final blade and the blade plane.

The relative difference between angles αₚ and o_{f} will result in a difference between efficiency and closeness and comfort between the primary blade and the final blade. The angle αₚ of the primary blade will result in the primary blade providing a more efficient/close shave relative to the final blade, but a user will likely experience more discomfort from the primary blade than the final blade. As the primary blade is exposed to most hair and accordingly typically cuts more hairs than other blades in a multi-blade cartridge, the inventors have found that the decrease in comfort caused by the increase in angle of the primary blade is offset by the efficiency of the shaving stroke. Any discomfort caused by the primary blade is further offset by the relatively smaller angle of the final blade. The greater efficiency of the increase in angle of the primary blade results in an overall closer shave and fewer required strokes. Thus, overall, a user will experience a closer/more efficient shave without a significant decrease in comfort.

### BRIEF DESCRIPTION OF THE DRAWINGS

Embodiments of the invention will hereinafter be described, by way of example, with reference to the accompanying drawings, in which:

FIG. 1 is a plan view of one possible embodiment of a wet shaving razor.

FIG. 2 is a schematic cross-sectional view of a razor cartridge through x-x of the wet shaving razor shown in FIG. 1.

FIG. 3 is a schematic view of a blade of a possible embodiment of the present invention.

FIG. 4 is a schematic cross-sectional view of an alternative embodiment of the present invention.

FIG. 5 is a schematic cross-sectional view of a further alternative embodiment of the present invention.

FIG. 6 is a further view of the embodiment shown in FIG. 4 showing an exposure plane.

### DETAILED DESCRIPTION OF THE INVENTION

The invention is applicable to razor cartridges in general that are used in a wet shaving system.

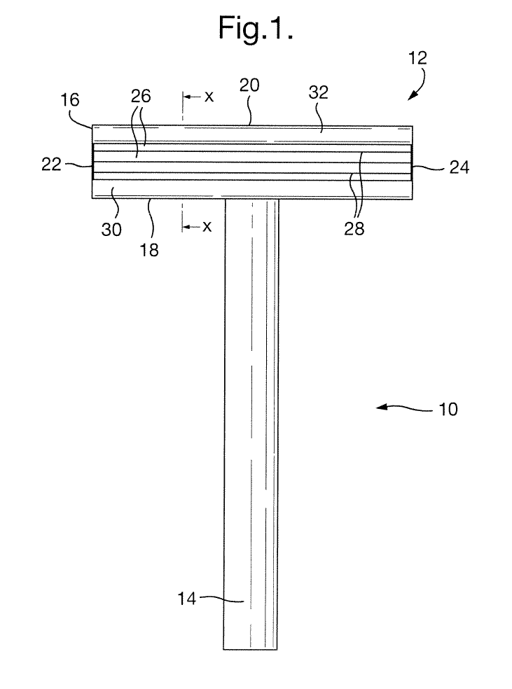

FIG. 1 shows a wet shaving razor 10 formed of a razor cartridge 12 attached to a handle 14. The razor cartridge is formed of a housing 16 having a front 18, a rear 20 and first and second opposing side walls 22, 24 disposed transverse to and between the front wall and rear wall. Two or more blades 26 with sharp cutting edges 28 are mounted within the housing 16 and extend between the first and second opposing side walls 22, 24. Three blades are shown in the embodiment of FIG. 1, however, it will be understood that more or fewer blades may be mounted within the housing 16. The razor cartridge 12 further has a guard 30 located ahead of the blades and a cap 32 located behind the blades. In the embodiment shown, the guard is disposed at the front end of the housing and the cap is disposed at the rear end of the housing. However, it will be appreciated that in an alternative embodiment, the respective positioning of the guard and cap may be reversed or the guard may be formed separately to the housing and mounted directly to the razor handle.

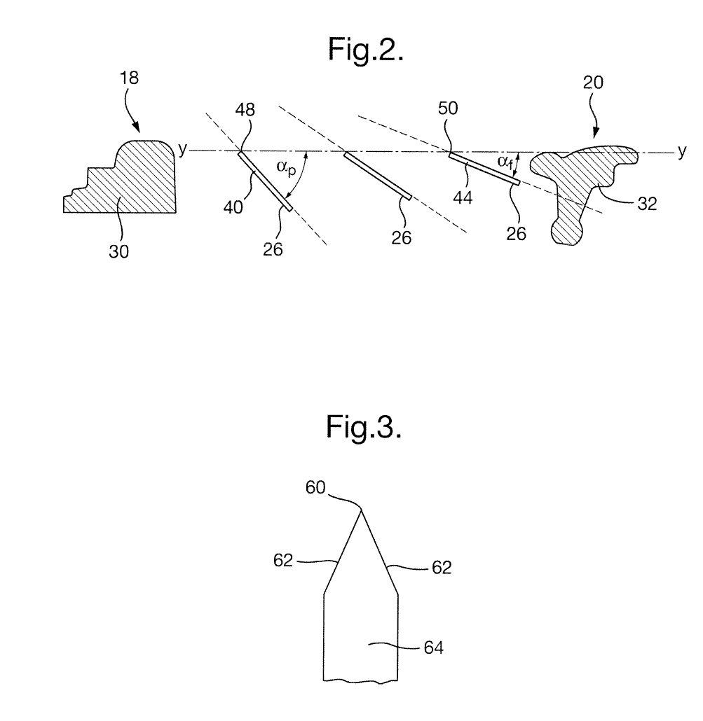

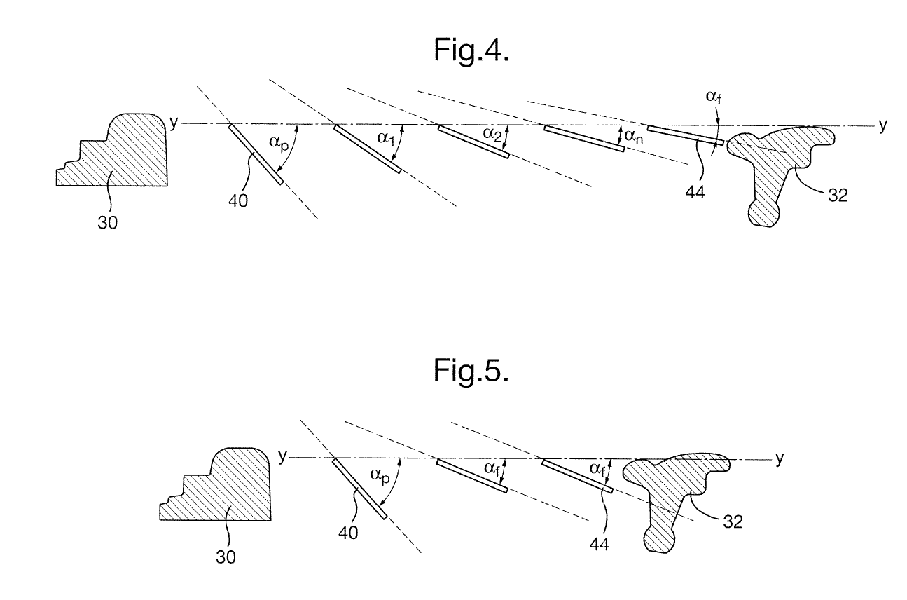

FIG. 2 shows the arrangement of blades in a cartridge having three blades 26. While this figure is shown with three blades, it will be appreciated that the cartridge could have fewer or more blades, for example, as shown in FIG. 4, where the cartridges have five blades. FIG. 2 shows a schematic cross-section through x-x of a cartridge shown in FIG. 1. The cartridge has a guard 30 located at the front of the cartridge and a cap 32 located at a rear of the cartridge. A primary blade 40 is located adjacent the guard 30 at the front end 18 of the cartridge and a final blade 44 is located adjacent the cap 32 at the rear end 20 of the cartridge. Both primary 40 and final blades 44 have blade edges 48, 50 that extend in parallel to a length of the cartridge. The blade edges lie in a blade plane y that is tangential to the primary blade edge 48 and the final blade edge 50. The blades 40, 44 extend away from the front end 42 of the cartridge at an angle α beneath the blade plane.

The primary blade 40 extends away from the blade plane y at an angle αₚ relative to the blade plane while the final blade 44 extends away from the blade plane y at an angle α_{f} relative to the blade plane. As shown in FIG. 2, the angle αₚ is greater than the angle α_{f}. The present inventors have found that by providing a blade with a greater angle at the front end of a cartridge relative to the angle of a blade at the rear end of the cartridge, it is possible to further improve the balance between comfort and closeness.

A typical blade edge is shown in FIG. 3, having a sharp tip 60 and facets 62 that extend away from the sharp tip into a body 64 of the blade. While shaving, a user is likely to experience varying degrees of comfort depending on how much of the blade edge is presented to skin. As the angle α is increased, the surface area of the blade presented to the skin decreases and thus the pressure on the skin increases, leading to an increase in discomfort experienced by a user. As the angle α is decreased, more of the facet 62 is presented to the surface of the skin, increasing the surface area of the blade presented to the skin and a user experiences less discomfort.

As explained above, however, there is a trade-off between the increase in comfort and a decrease in efficiency and closeness of a shave. In this respect, as the angle α is decreased, there is a greater likelihood that contact between a blade edge and a hair will result in a “skive-cut”. A skive-cut occurs when the blade edge cuts into one side of a hair and, rather than cutting straight across the hair, cuts diagonally through the shaft, leaving one side of the hair longer than another side. By not cutting a hair cleanly, a user may need to shave more frequently, or increase the number of shaving strokes. By contrast, as the angle α is increased, there is less chance that contact between a blade edge and hair will result in a skive-cut, and the sharp tip 60 will penetrate hairs closer to the skin, thus resulting in a more efficient/close shave.

The present inventors have found that increasing the blade angle for all blades in a cartridge decreases the level of comfort experienced by a user by an unacceptable amount. However, by varying the angle of blades across a cartridge, it is possible to balance a slight decrease in comfort with increased efficiency across some blades, provided that for other blades, the balance is tipped towards increased comfort with a possible resultant decrease in efficiency.

FIG. 4 shows an embodiment having additional blades positioned between the primary blade and the final blade. Although FIG. 4 shows a cartridge having three additional blades, it will be appreciated that the described invention will apply equally to more than three additional blades. Accordingly, the cartridge may have n additional blades, where n may be between 1, 2 and 3 to 4, 5 and 6. In all cases, the first additional blade is located adjacent the primary blade and the nth additional blade is located adjacent the final blade.

In the embodiment shown in FIG. 4, the primary blade is positioned at an angle αₚ of between about 25°, 27°, 29°, 31° and 33° to 35°, 37°, 39°, 41°and 44°. The angle α_{1-n, f} of each subsequent blade is between 1° and 2° to 3° to 4° less than the angle α of the preceding blade. In one embodiment, the angle α of each blade is about 2.5° less than the angle α of the blade that precedes it. For example, if the angle αₚ of the primary blade is 41°, the angle α₁ of the first additional blade may be 38.5, the angle α₂ of the second additional blade 35°, the angle α₃ of the third additional blade 31.5° and the angle of the final blade 29°. In an alternative embodiment where the angle α of each blade is about 1° less than the angle α of the preceding blade, the angle αₚ of the primary blade may be 27°, the angle α₁ of the first additional blade 26°, the angle α₂ of the second additional blade 25°, the angle α₃ of the third additional blade 24° and the angle α_{f} of the final blade 24°. It will further be appreciated that in embodiments where n=0 or 1, the angle α of a blade may be between 1° and 8° less than the angle α of the preceding blade.

In each of these cases, the first blade is expected to cut most efficiently but may cause the greatest amount of discomfort to a user. By contrast, the final blade will cut least efficiently, but will also cause the least amount of discomfort to a user.

In an embodiment shown in FIG. 5, the primary blade is positioned at an angle αₚ of between about 25°, 27°, 29°, 31° and 33° to 35°, 37°, 39°, 41° and 44°. The first to nth additional blades and the final blade are all positioned at an angle α_{n-1,f} between about 2°, 3° and 4° to about 5°, 6°, 7° and 8° less than αₚ.

In an alternative embodiment, not shown, the primary blade and one or more of the additional blades are positioned at an angle αₚ of between about 25°, 27°, 29°, 31° and 33° to 35°, 37°, 39°, 41° and 44° and any remaining additional blades and the final blade are positioned at an angle α_{f} of between about 2°, 3° and 4° to about 5°, 6°, 7° and 8° less than αₚ.

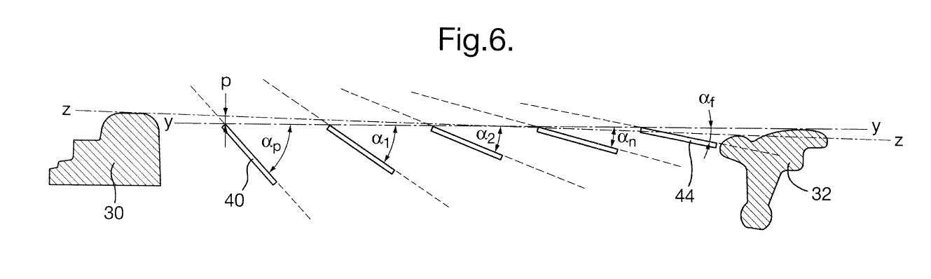

FIG. 6 shows an exposure plane z which is tangential to skin engaging surfaces of the guard 30 and cap 32. “Exposure” of a blade is defined as the distance, p, of the blade edge 28 from the exposure plane. Where a blade edge lies beneath the exposure plane, this is classified as a “negative exposure”. If the blade lies above the exposure plane, this is classified as a “positive exposure”. If the blade edge lies in the exposure plane, the blade edge has zero exposure.

In a preferred embodiment shown in FIG. 6, the primary blade 40 has negative exposure, the final blade 44 has positive exposure and the exposure of any additional blades between the primary and final blades have progressively increasing exposure from the front to rear of the cartridge. This form of progressive geometry is described in detail in EP 0 722 379. Variation in blade exposure across a cartridge results in a varied load distribution across the blades of a cartridge. The load on respective blades reduces as the exposure is reduced. Accordingly, in the cartridge as shown in FIG. 6, least load is applied to the primary blade during shaving while most load is applied to the final blade. This is a result of the pressure applied to skin by the blades during shaving—where the blade protrudes more relative to the exposure plane, effectively the skin contact plane, while shaving, the blade protrudes further into skin

In preferred embodiments of the invention, the primary blade has a greater angle relative to the blade plane compared with the other blades in the cartridge and the primary blade has lower exposure compared with other blades in the cartridge. Thus, any decrease in comfort felt by the increase in blade angle is offset by the reduction in load applied to that blade. Where exposure and, accordingly, the load is greatest, the angle of the blade relative to the blade plane is smallest to maximize the feeling of comfort.

The blades of the present invention may be secured to the housing in any known way, for example, the blades may be attached to blade supports, or they may be bent blades that are secured directly to the housing. In embodiments of the present invention, the housing has a blade retaining member having a plurality of slots for receiving either the blade supports or, where bent blades are used, the blades. The angle of the respective blades relative to the blade plane can be determined by an angle in the blade support, where blade supports are used, or by a bend in a blade where bent blades are used. Alternatively, the angle of bend in the respective blade supports or bent blades may be kept the same, and the angle of the respective slots in the blade retaining member may be varied to result in blade edges at varying angles to the blade plane.

In typical cartridges, the blades are usually carried by the housing, which is generally a molded plastic frame, either independently of each other or in unison under forces imparted on the blades by the skin during shaving. In one embodiment of support within the housing, the blades are mounted fixedly within slots in a blade retaining member. In most instances, there will be one or more rigid blade retaining member disposed along a length of the housing to provide adequate and immovable support for the blades disposed therein. In another instance, the blades may be floatably mounted within the housing. Here, the plurality of blades is supported by one or more spring loaded blade retaining member where the blades are permitted to respond to the forces encountered during shaving.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A wet shaving razor cartridge (12), comprising:
a) a housing (16);
b) a guard (30) located at a front (18) of the housing (16) and a cap (32) located at a rear (20) of the housing (16);
c) a primary blade (40) adjacent the guard (30) and a final blade (44) adjacent the cap (32), the primary (40) and final (44) blades having blade edges (48, 50) that extend in parallel to a length of the housing (16);
d) a blade plane (y) tangential to the primary blade edge (48) and the final blade edge (50), wherein an angle αₚ between the primary blade (40) and the blade plane (y) is greater than an angle α_{f} between the final blade (40) and the blade plane (y).

2. A wet shaving razor cartridge as claimed in claim 1, wherein the angle αₚ between the primary blade (40) and the blade plane (y) is at least about 4° greater than the angle α_{f} between the final blade (44) and the blade plane (y).

3. A wet shaving razor cartridge as claimed in claim 1, wherein the angle αₚ is between about 25° and 44°.

4. A wet shaving razor cartridge as claimed in any of claim 1, further comprising a first to nth additional blade between the primary blade (40) and the final blade (44), the first additional blade being adjacent the primary blade (40) and the nth additional blade being adjacent the final blade (44), wherein the angle α₁₋ₙ of each of the first to nth additional blade is less than αₚ and greater than or equal to α_{f}.

5. A wet shaving razor cartridge as claimed in claim 4, wherein the angle α_{p, n-1, f} of each blade relative to the blade plane (y) progressively decreases from the primary blade (40) to the final blade (44).

6. A wet shaving razor cartridge as claimed in claim 5, wherein the angle α between each blade and the blade plane is about 2.5° less than the angle α between the preceding blade and blade plane.

7. A wet shaving razor cartridge as claimed in claim 5, wherein n=1 and the angle α between each blade and the blade plane is between about 1° and 8° less than the angle α between the preceding blade and blade plane.

8. A wet shaving razor cartridge as claimed in claim 6, wherein the angle α between each blade and the blade plane is about 2.5° less than the angle α between the preceding blade and blade plane.

9. A wet shaving razor cartridge as claimed in claim 5, wherein n=2 or more, and the angle α between each blade and the blade plane is between about 1° and 4° less than the angle α between the preceding blade and blade plane.

10. A wet shaving razor cartridge as claimed in claim 7, wherein the angle α between each blade and the blade plane is about 2.5° less than the angle α between the preceding blade and blade plane.

11. A wet shaving razor cartridge as claimed in claim 1, further comprising a first to nth additional blade between the primary blade and the final blade, the first additional blade being adjacent the primary blade and the nth additional blade being adjacent the final blade (44), wherein the angle α of at least one additional blade is equal to the angle αₚ of the primary blade (40).

12. A wet shaving razor cartridge as claimed in claim 1, wherein the exposure of each blade edge relative to an exposure plane progressively increases from the primary blade to the final blade.
